(19) United States
(12) Patent Application Publication
(10) Pub. No.: US 2019/0101245 A1
(43) Pub. Date: Apr. 4, 2019

(54) SYSTEMS AND METHODS FOR MANAGEMENT OF CRYOGENIC STORAGE VESSELS

(71) Applicants: JOHN L. ROMANOS, MOBILE, AL (US); KEVIN M. OEFF, INDIANAPOLIS, IN (US)

(72) Inventors: JOHN L. ROMANOS, MOBILE, AL (US); KEVIN M. OEFF, INDIANAPOLIS, IN (US)

(21) Appl. No.: 16/148,020

(22) Filed: Oct. 1, 2018

Related U.S. Application Data
(60) Provisional application No. 62/566,900, filed on Oct. 2, 2017.

(51) Int. Cl. F17C 5/00; F17C 13/02; F17C 5/02; F17C 13/00

(52) U.S. Cl. CPC F17C 5/002; F17C 13/025; G01F 23/247; F17C 13/001; F17C 5/02

(57) ABSTRACT

Dual level sensing, vacuum monitoring, smart supply cylinders, smart oxygen monitors, and real time data collection functionality are integrated with a cryogenic storage system to improve sample safety and user safety. The dual level sensing system includes two liquid nitrogen level sensors installed into a cryogenic freezer that send redundant level information to a controller. Vacuum monitoring is performed via a gauge, installed on a vacuum port, that communicates data to the controller. The controller further receives level information from supply cylinders and oxygen levels from one or more oxygen monitors. The aforementioned data sources can be integrated into control decisions executed by the controller. In addition, all operational data of the cryogenic storage system is communicated to a cloud-based platform to provide real-time status monitoring, trend analysis, and alarm notifications.

### CROSS-REFERENCE TO RELATED APPLICATIONS

This application claims the benefit of and priority to U.S. Provisional Application No. 62/566,900, filed on Oct. 2, 2017. The entirety of this application is incorporated by reference.

### TECHNICAL FIELD

In general, the present invention relates to cryogenic storage vessels and, in particular, to sensor systems, control systems, and a cloud-based platform to facilitate improved operation and maintenance of the storage vessels.

### BACKGROUND OF THE INVENTION

Liquid nitrogen freezers with electronic control systems can provide automatic filling operations. Typical operation involves a START FILL parameter and a STOP FILL parameter established in a controller. When a level of liquid nitrogen (LN₂) in the freezer falls below a level specified by the START FILL parameter, the controller opens a cryogenic solenoid valve to allow LN₂ to flow into the freezer. When the level of LN₂ inside the freezer reaches a level set for the STOP FILL parameter, the controller closes the cryogenic solenoid valve to stop the flow of LN₂ into the freezer. This control scheme generally maintains the LN₂ level in the freezer within an acceptable range to provide for storage of items in the freezer at acceptable temperatures. The control scheme relies on a level sensor to provide consistent, accurate level readings to the controller.

A weakness of existing systems centers on the single point of failure associated with the control scheme described above. In particular, there is an inherent risk associated with failure of the level sensor. Such failure would inhibit the controller's ability to maintain an acceptable LN₂ level. Although other parameters, such as temperature, can be monitored in existing systems and a local alarm can issue if a problem develops, the single point of failure associated with the level sensor weakens reliability of the overall system.

A liquid nitrogen freezer can be a double-walled vessel with a vacuum and multi-layer insulation (MLI) located between an inner wall and an outer wall of the vessel. This structure provides an effective barrier to heat entering the vessel via conduction, convection, and/or radiation and, thus, renders the vessel suitable for storing products at extremely low temperatures. Conventional liquid nitrogen freezers, however, have an inherent operational risk associated with an inability to measure and communicate a vacuum integrity of a freezer, once put into service. A typical measurement technique, referred to as normal evaporation rate (NER), involves filling a freezer with a specified amount of LN₂ and weighing the freezer. Over a given test period, the freezer is repeatedly weighed at intervals. The weight of the freezer changes, over time, due to LN₂ evaporation. The rate of evaporation is a proxy measurement for the integrity of the vacuum.

Liquid nitrogen freezers use LN₂ as a refrigerant to maintain cryogenic temperatures. The LN₂ is supplied by a variety of vessels including supply cylinders, microbulk tanks, and bulk tanks. The vast majority of freezers, however, are supplied by supply cylinders having volumes approximately ranging between 160 and 240 liters. A level of LN₂ in a supply cylinder is typically determined, manually, by viewing a gauge coupled to a float mechanism inside the supply cylinder or by shaking the cylinder to determine a weight. Conventionally, standard operating procedures and delivery schedules are relied on to insure a liquid nitrogen freezer is kept at an appropriate supply level.

Further, liquid nitrogen freezers produce nitrogen (N₂) gas during filling operations. This occurs due to evaporation from LN₂ cooling warm plumbing assemblies and from warm, mixed-phase N₂ entering the cold pool of LN₂ in the freezer. Nitrogen gas displaces oxygen, which potentially creates a hazardous environment for any person in the vicinity of a freezer being filled. A freezer in a closed space presents an even greater hazard.

In addition, some liquid nitrogen freezers collect operational data of the freezer such as, for example, temperature, liquid level, and alarm conditions. The operational data is typically stored in memory on a control board installed on the freezer.

### SUMMARY OF THE INVENTION

A simplified summary is provided herein to help enable a basic or general understanding of various aspects of exemplary, non-limiting embodiments that follow in the more detailed descriptions and the accompanying drawings. This summary is not intended, however, as an extensive or exhaustive overview. Instead, the sole purpose of the summary is to present some concepts related to some exemplary non-limiting embodiments in a simplified form as a prelude to the more detailed description of the various embodiments that follow.

In various, non-limiting embodiments, a cryogenic storage system is provided that includes a storage vessel configured to contain a cryogenic liquid to provide a cryogenic temperature suitable for storage of items. The system further includes a dual-layer level measurement system configured to provide redundant measurement of a level of cryogenic liquid within the storage vessel. In addition, the system includes a controller configured to obtain level measurements from the dual-layer level measurement system and to control filling operations of the storage vessel based at least in part on the level measurements.

These and other features of this invention will be evident when viewed in light of the drawings, detailed description and appended claims.

### BRIEF DESCRIPTION OF THE DRAWINGS

The invention may take physical form in certain parts and arrangements of parts, a preferred embodiment of which will be described in detail in the specification and illustrated in the accompanying drawings which form a part hereof, and wherein:

FIG. 1 illustrates a block diagram of an exemplary, non-limiting cryogenic storage system according to one or more aspects;

FIG. 2 illustrates an exemplary, non-limiting embodiment of a controller for the cryogenic storage system of FIG. 1;

FIG. 3 illustrates an exemplary, non-limiting embodiment of a differential pressure system for a cryogenic storage system in accordance with various aspects;

FIG. 4 illustrates an exemplary, non-limiting embodiment of a thermistor-based system for a cryogenic storage system according to one or more aspects;

FIG. 5 illustrates an exemplary, non-limiting embodiment of a thermistor-based system for a cryogenic storage system in accordance with various aspects;

FIG. 6 illustrates an exemplary, non-limiting embodiment of a vacuum monitor associated with a cryogenic storage system;

FIG. 7 illustrates an exemplary, non-limiting embodiment of system communications in accordance with one or more aspects;

FIG. 8 illustrates an exemplary, non-limiting embodiment of a supply vessel with level sensing system according to one or more aspects;

FIG. 9 illustrates an exemplary, non-limiting oxygen monitor;

FIG. 10 is a flow diagram for an exemplary, non-limiting embodiment for controlling a cryogenic storage system according to various aspects;

FIG. 11 is a flow diagram for an exemplary, non-limiting embodiment for utilizing level measurements in a cryogenic storage system;

FIG. 12 is a flow diagram for an exemplary, non-limiting embodiment for utilizing a thermistor-based level sensing system in accordance with one or more aspects;

FIG. 13 is a flow diagram for an exemplary, non-limiting method for automatic validation of level measurements;

FIG. 14 is an exemplary screenshot of a dashboard display of a cloud-based platform;

FIG. 15 is an exemplary screenshot of a history display of a cloud-based platform;

FIG. 16 is an exemplary screenshot of a graph display of a cloud-based platform;

FIG. 17 is an exemplary screenshot of a notifications display of a cloud-based platform;

FIG. 18 is an exemplary screenshot of a display, of a cloud-based platform, showing integration with on oxygen monitor; and

FIG. 19 is a block diagram representing an exemplary, non-limiting networked environment, including cloud or internet based, in which various embodiments described herein can be implemented.

### DETAILED DESCRIPTION OF THE INVENTION

In liquid nitrogen (LN₂) freezers, maintaining appropriate temperatures is vital to the safety and viability of stored products (e.g. samples). Sample safety and user safety is greatly improved with application of various techniques, individually or jointly, with LN₂ freezers to mitigate risks associated with single points of failure. These techniques include utilizing a dual level sensing system, acquiring data related to vacuum integrity and temperature profile, communicating with supply cylinders, obtaining information on oxygen levels, and transmitting operational data to a cloud-based platform that performs analytics and enables a sophisticated notification system.

A dual level sensing system provides an enhanced LN₂ level measurement that includes all advantages of conventional level measurement systems (e.g. singular differential pressure (DP) sensors, negative temperature coefficient (NTC) thermal resistors or thermistors, capacitance probes, superconductivity resistance measurements, and/or load cells). In addition, dual level sensing provides level measurement in a redundant format to corroborate results. According to an example, the dual levels sensing system can include a primary level sensing system having a differential pressure (DP) sensor and a secondary level sensing system having a set of NTC thermistors placed in a separate sensor tube on a vessel.

The differential pressure level measurement system can include two tubes originating on an upper head of the vessel and extending through an annular space (e.g., between an inner wall and an outer wall of the vessel) into an inner chamber of the vessel where LN₂ is present. A high pressure port of the differential pressure sensor connects to a first tube that terminates in a lower part of the inner chamber. The LN₂ inside the vessel pushes against N₂ gas trapped within the first tube. The more LN₂ present inside the vessel, the harder the push is against the trapped N₂ gas within the first tube, which increases the pressure. This pressure is measured and represents a high pressure side in the differential pressure measurement. A low pressure port of the differential pressure sensor connects to a second tube that terminates in an upper part of the inner chamber above the pool of LN₂. A differential maintained between the high pressure and low pressure ports is utilized to determine a level of liquid nitrogen in the vessel. A buildup of pressure in the vessel due to evaporation is measured by both high pressure and low pressure ports, which effectively cancels out this phenomena on both sides of the equation. The high pressure and the low pressure measurements are communicated to a controller which interprets the differential pressure into a level.

A thermistor-based level measurement system can include a set of thermistors installed onto a printed circuit board at particular locations along the length of the circuit board. The circuit board is installed into a tube originating on the upper head of the vessel and extending down through the annular space into the inner chamber of the vessel where LN₂ is present. The tube has entry points into the inner chamber at two points. The first point is close to a bottom of the vessel to allow LN₂ to enter the tube and achieve equilibrium with the LN₂ level inside the vessel. The second entry point can be located in the upper part of the inner chamber above the pool of LN₂. The two entry allow level equilibrium to be achieved. That is, as LN₂ enters the bottom of the tube and moves upwards, a gas pocket above the LN₂ in the tube is pushed back into the vessel through the second entry point. This eliminates any gas trap that would hinder the flow of LN₂ into the tube.

The thermistor-based level measurement system can include a cable coupled to the circuit board to transmit signals to the controller. In addition, the system can include a tube-to-pipe fitting for connecting to the sensor tube and accommodating a cord grip to secure the cable. The fitting also seals the top of the tube against air movement that could promote ice formation. The controller can determine a level based on received thermistor signals.

Monitoring an integrity of a vacuum throughout the operational life of a cryogenic storage system subsumes the benefits of NER testing, while providing more accurate and more frequent readings appropriate for use in trend analysis. Thus, according to an aspect, a vacuum measurement system is installed at a plug where a vacuum is pulled. The measurements from the system can be communicated to a controller and/or a cloud-based platform.

According to yet another aspect, a level of LN₂ in a supply cylinder can be measured and communicated to the controller of the cryogenic storage system as well as to operators, a LN₂ distributor, etc. A supply cylinder monitor provides accurate supply information to ensure an adequate supply of LN₂ is available for operation of the cryogenic storage system. In one example, a capacitive probe is installed into a supply cylinder to measure an LN₂ level. This data is transmitted to the controller of the cryogenic storage system, operators, and/or distributors. If a low supply of LN₂ is detected, the controller can adjust operations to conserve LN₂. Moreover, operators can be notified to trigger remedial action and the distributor can be notified to perform immediate delivery of additional LN₂.

In yet another aspect, an oxygen monitor can be installed in a room with a cryogenic storage system. The monitor measures an oxygen level and communicates this information to the cryogenic storage system and/or a cloud-based platform. The cryogenic storage system can temporarily halt filling operations if low oxygen levels are detected in the vicinity of the storage vessel. The cloud-based platform can, upon receipt of reports of low oxygen levels, notify operators as a safety precaution until adequate oxygen levels are restored.

Still further, the cloud-based platform disclosed herein provides benefits of conventional data logging detailed above along with additional improvements due to nearly unlimited data storage capacity, storage redundancy, global accessibility, quick notifications for alarms, analytics, and remote troubleshooting capabilities. According to an example, a local communication network of a cryogenic storage system can interface to another communication network (i.e. the Internet or other TCP/IP network) to transmit data to the cloud-based platform. The data can be encrypted for secure transmission and include temperature, LN₂ levels, oxygen levels, etc. Temperature and fluid levels can be periodically transmitted at configurable intervals (e.g. every x minutes) while other parameters may be transmitted to the cloud when changes are detected. Alarm conditions can trigger critical data collection and transmission.

According to one aspect, the cloud-based platform can provide a dashboard showing all connected equipment along with simplified, at-a-glance statuses of the equipment. A history display of the cloud-based platform provides detailed operational data of a system. A graph display provides visualization of liquid level and temperature to operators. A notification display of the cloud-based platform enables customization of notification triggers, recipients, and other settings.

As noted above and described in greater detail below, systems and method are disclosed herein to provide improved LN₂ level measurements for cryogenic storage systems. The level sensor system can provide redundancy such that, if a primary sensor fails, a secondary sensor can be utilized to monitor the LN₂ level in the freezer and facilitate level control. The redundant or dual sensor system eliminates a single point of failure in relation to level sensing and provides improved sample safety by reducing a risk of a sensor failure causing a rise in sample temperatures. The redundant sensor system includes a thermistor-bases system that provides discrete points of measurements usable as redundant alarm points. For instance, discrete sensors at known heights can be compared with readings from a primary (differential pressure based) sensor system to verify level readings. The data from the differential pressure sensor system can be utilized to cancel out pressure spike readings resulting from evaporation during a filling operation.

Further, the systems and methods described herein provide measurement and monitoring of vacuum integrity throughout the expected service life of a cryogenic storage system. Vacuum integrity measurements can be stored and analyzed to determined trends and/or predict an expected end-of-life (EOL) for the cryogenic storage vessel. The vacuum integrity measurements can be analyzed with other parameters, such as temperature and fill frequency, to improve sample safety.

The systems and methods herein also provide level measurement for supply cylinders. This information can be transmitted to a controller to modify operation of the cryogenic storage system to conserve LN₂. The information can also be communicated to gas suppliers (distributors) to provide timely supply of LN₂ and to enterprises to improve efficient distribution within an organization. The information can also enable distributors to identify damaged supply cylinders and remove them from service for repairs.

Oxygen monitoring enables oxygen level information to be communication to a controller so that a filling operation can be temporarily suspended to allow oxygen levels to increase to safe levels. Personnel can be notified to avoid unsafe areas until oxygen levels are restored.

As noted above and described later, the cloud-based platform collects operational data and performs analytics on the data to identify trends indicative of operational problems. Through data collection and storage in the cloud, the real time status of a cryogenic storage system and products stored within the storage vessel is available. Historical data is analyzed to determine trends. Graphs of the data can be generated to provide visualizations of key parameters. Further, the cloud-based platform provides a notification system for real-time notification of errors with complete information of all parameters. The notifications can be customizable in terms of alarms, equipment, recipients, and time blocks.

In one embodiment, a cryogenic storage system is described. The system includes a storage vessel having a storage chamber and configured to contain a cryogenic liquid to provide a cryogenic temperature within the storage chamber suitable for cryogenic storage of items. The system further includes a dual-layer level measurement system configured to provide redundant measurement of a level of the cryogenic liquid within the storage vessel. In addition, the system includes a controller configured to obtain level measurements from the dual-layer level measurement system and to control filling operations for the storage vessel based at least in part on the level measurements.

According to an example, the dual-layer level measurement system includes a differential-pressure-based level measurement system. The differential-pressure-based level measurement system can include a first tube that penetrates into the storage chamber of the storage vessel at a point below the level of cryogenic liquid and a second tube that penetrates into the storage chamber at a point above the level of cryogenic liquid. The first tube provides a high pressure measurement and the second tube provides a low pressure measurement. The controller can be further configured to analyze the high pressure measurement and the low pressure measurement to determine the level of cryogenic liquid within the storage vessel. In another example, the dual-layer level measurement system includes a thermistor-based level measurement system. The thermistor-based level measurement system can include a tube having a first penetration into the storage chamber of the storage vessel at a point below the level of cryogenic liquid and a second penetration at a point above the level of cryogenic liquid, and a circuit board mounted within the tube and carrying a set of thermistors. The thermistors of the set of thermistors are positioned on the circuit board at discrete points corresponding to particular levels of liquid. The particular levels of liquid include a lower alarm level, a start fill level, a stop fill level, and a higher alarm level. The thermistor-based level measurement system can further include a cable for communicating signals from the thermistors to the controller. The controller can be further configured to interpret respective resistances of the set of thermistors to determine the level of cryogenic liquid within the storage vessel.

In other examples, the system can include a storage container storing a supply of cryogenic liquid for the storage vessel, wherein the storage container includes a level sensor configured to communicate a level of fluid stored in the storage container to the controller. The system can also include a vacuum measurement device coupled to a vacuum port of the storage vessel and configured to measure a vacuum integrity of the storage vessel. The system can also include an oxygen monitor configured to measure an oxygen level in a vicinity of the storage vessel and communicate the oxygen level to the controller. In addition, the system can include a cloud platform configured to collect operational data of the cryogenic storage system, analyze the operational data for trends, and communicate notifications to users in response to identified conditions.

In another embodiment a method for a cryogenic storage system is described. The method can include collecting data from a differential-pressure-based level measurement system. The method can further include determining a first level of cryogenic fluid within a storage vessel based on the data from the differential-pressure-based level measurement system. The method can also include collecting data from a thermistor-based level measurement system and determining a second level of cryogenic fluid within the storage vessel based on the data from the thermistor-based level measurement system. In addition, the method can include controlling filling operations for the storage vessel based at least in part on the first and second levels of cryogenic fluid.

In one example, the method can include triggering alarms based on the first and second levels of cryogenic fluid. In addition, the method can also include comparing the first level and the second level, and determining that the first level and second level agree in accordance with validation parameters. The validation parameters specify a threshold level of disagreement between the first and second levels that is acceptable to determine the levels agree. In another example, the thermistor-based level measurement system comprises a set of thermistors and the data collected from the thermistor-based level measurement system includes a resistance value for each thermistor of the set of thermistors. Accordingly, the method can include determining whether the resistance values for each thermistor of the set of thermistors specify an invalid scenario.

In yet another embodiment, a system is provided. The system can include a cryogenic storage vessel having a storage chamber configured to contain a cryogenic fluid to provide a cryogenic temperature within the storage chamber. The system can also include a differential-pressure-based level measurement system configured to determine a first level measurement of the cryogenic fluid within the storage chamber. In addition, the system can include a thermistor-based level measurement system configured to determine a second level measurement of the cryogenic fluid within the storage chamber. The system can additionally include a supply container storing a supply of cryogenic liquid for the cryogenic storage vessel, wherein the supply container includes a level sensor configured to measure a level of fluid stored in the supply container. Further, the system can include a vacuum measurement device coupled to a vacuum port of the cryogenic storage vessel and configured to measure a vacuum integrity of the cryogenic storage vessel. In addition, the system can include an oxygen monitor configured to measure an oxygen level in a vicinity of the cryogenic storage vessel. In a further aspect, the system can include a controller configured to obtain data from the differential-pressure-based level measurement system, the thermistor-based level measurement system, the level sensor of the supply container, the vacuum measurement device, and the oxygen monitor, herein the controller executes control actions based on the obtained data. Furthermore, the system can include a cloud system configured to collect operational data of the system, analyze the operational data for trends, and communicate notifications to users in response to identified conditions.

These and other advantages of the systems and methods provided herein will be apparent to one of ordinary skill in the art.

With reference to the drawings, like reference numerals designate identical or corresponding parts throughout the several views. The inclusion of like elements in different views does not mean a given embodiment necessarily includes such elements or that all embodiments of the invention include such elements. The examples and figures are illustrative only and not meant to limit the invention, which is measured by the scope and spirit of the claims. Moreover, it should be understood that the drawings may not depict features to scale. Specific design features of pressure vessels, similar to those disclosed herein, such as, for example, specific dimensions, orientations, locations, and/or shapes are generally determined, in part, by a particular application and/or use environment. The drawings may enlarge or exaggerate certain features to facilitate visualization.

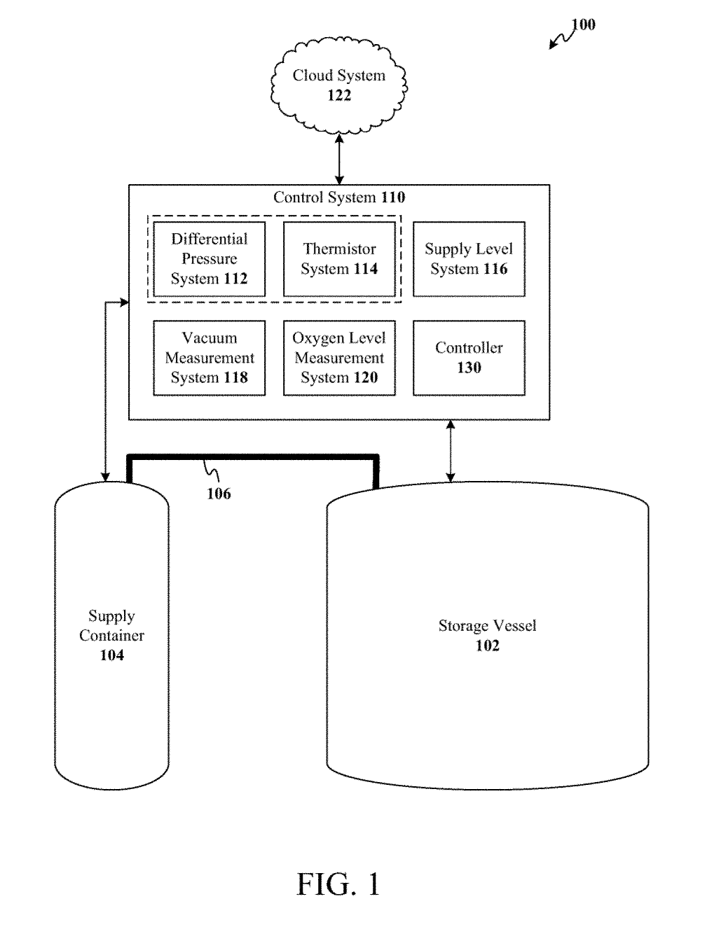

FIG. 1 illustrates an exemplary, non-limiting embodiment of a cryogenic storage system 100. The system 100 includes a freezer or storage vessel 102 configured to store samples or other products at cryogenic temperatures. For instance, the storage vessel 102 can contain a pool of liquid nitrogen (LN₂) or other cryogenic fluid. The storage vessel 102 can be coupled to a supply container 104, via a plumbing system 106, for periodically filling the storage vessel 102 with LN₂ as needed due to evaporative losses and other factors. In addition, the storage vessel 102 and the supply container 104 are communicatively coupled to a control system 110 configured to control the operation of the storage system 100. For example, the control system 110 can obtain data from various sensors coupled to the storage vessel 102 and/or supply container 104, analyze collected data to determine if actions should be taken, and execute any actions determined to be needed. Executing actions can include, for instance, signaling valves to open to permit a flow of LN₂ from the supply container 104 to the storage vessel 102 (i.e. a filling operation). Other actions can include, without limitation, triggering visual and audible alarms based on system status, transmitting data to various recipients, adjusting standard operating cycles based on system status, or substantially any other action related to the operation of the storage system 100.

According to an aspect, control system 110 is configured to integrate various sensor, monitoring, or analysis systems to enhance operation of the storage system 100 and improve product and operator safety. A dual LN₂ level measurement system provides redundant level sensing to determine an accurate and confirmed level of LN₂ in the storage vessel 102. The dual level sensing system can be implemented by differential pressure system 112 and thermistor system 114. Differential pressure system 112 obtains a high pressure measurement and a low pressure measurement from disparate areas within the storage vessel 102. Based on a differential between the two measurements, a LN₂ level is determined. The determined level can be confirmed by thermistor system 114, which obtains readings from a set of thermistors located at discrete positions within the storage vessel 102. A pattern of the readings obtained from the set of thermistors can indicate the LN₂ level. The control system 110 may utilize the LN₂ level to initiate a filling operation or stop the filling operation in accordance with configured parameters (i.e. START FILL and STOP FILL).

A supply level system 116 facilitates measurement of a level of LN₂ available in the supply container 104. For example, a capacitive probe or other measuring device can generate data indicative of the level of LN₂ within the supply container 104. The control system 110 can initiate conservation measures in response to a low level until the supply container 104 can be replaced. For instance, the control system 110 can decrease a fill frequency (i.e. increase an interval between filling) to stretch the supply while maintaining a temperature in the storage vessel 102 within an acceptable range.

The storage vessel 102 may be a double-walled vessel with a vacuum and multi-layer insulation (MLI) located between an inner wall and an outer wall of the vessel. The inner wall defines an inner chamber which houses samples or other products to be held at cryogenic temperatures. The integrity of the vacuum can relate to an evaporation rate and, consequently, how often the storage vessel 102 requires filling and how much LN₂ is consumed through filling operations to maintain a desired temperature. System 100 includes a vacuum measurement system 118 to measure the vacuum, which can provide data suitable to analyze trends.

The oxygen level measurement system 120 includes an oxygen monitor positioned in a vicinity of the storage vessel 102. The oxygen monitor can measure an oxygen level in the area and provide this information to the control system 110 to determine when a filling operation displaces too much oxygen. The control system 110 can temporarily halt filling operations until the oxygen level is restored to a safe level.

As shown in FIG. 1, the control system 110 can include an interface to couple the control system 110 (and the sensors and monitors associated therewith) to a communications network such as the Internet, a LAN, or other TCP/IP network. For instance, the interface can communicatively couple the control system 110 to a cloud system 122 that provides notification capabilities, redundant data storage, and trend analysis functionality. In addition, the control system 110 can include a controller 130 (e.g. a microprocessor-based controller) that acquires data from the sensor systems shown in FIG. 1, communicates with cloud system 122, and effects operational control of the cryogenic storage system 100.

The foregoing discussion is a broad overview of aspects of an enhanced cryogenic storage system according to various embodiments. What follows are detailed discussions of each feature that individually improves the cryogenic storage system and, when taken together, synergistically enhance operational efficiency and capabilities of the storage system.

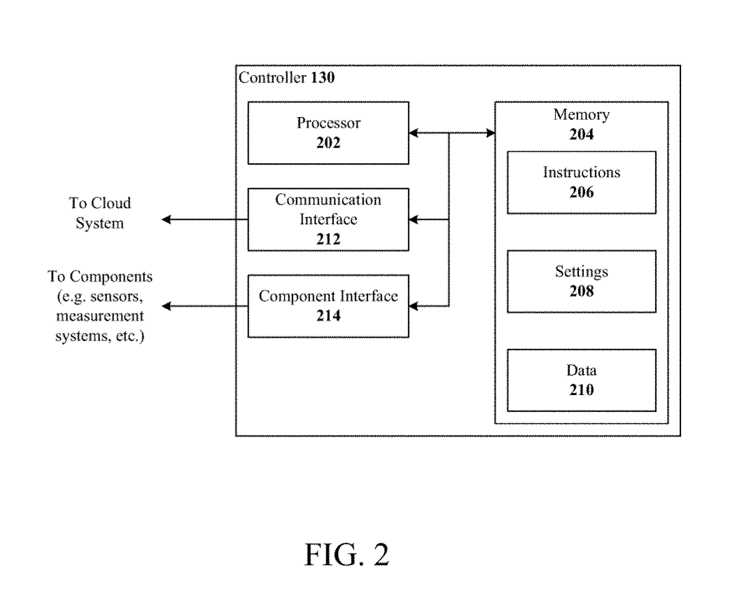

Turning to FIG. 2, illustrated is a schematic block diagram of an exemplary, non-limiting embodiment for a controller 130. As shown in FIG. 2, controller 130 includes one or more processor(s) 202 configured to execute computer-executable instructions 206 such as instructions composing a control, data acquisition, and communication process for a cryogenic storage system. Such computer-executable instructions 206 can be stored on one or more computer-readable media including non-transitory, computer-readable storage media such as memory 204. For instance, memory 204 can include non-volatile storage to persistently store instructions 206, settings 208 (e.g. configuration settings, parameter settings, fill level setpoints (i.e. START FILL, STOP FILL), etc.), and/or data 210 (e.g., operational data, history data, fluid level data, oxygen level data, temperature data, etc.). Memory 204 can also include volatile storage that stores instructions 206, other data (working data or variables), or portions thereof during execution by processor 202.

Controller 130 includes a communication interface 212 to couple controller 130, via the Internet or other communications network, to various remote systems such as, but not limited to, cloud system 122, client devices, other controllers, or Internet-enabled devices (e.g., IoT sensors). Communication interface 212 can be a wired or wireless interface including, but not limited, a WiFi interface, an Ethernet interface, a Bluetooth interface, a fiber optic interface, a cellular radio interface, a satellite interface, etc. The communications interface 212 can be configured to communicate with cloud system and/or other devices through a local area network co-located with the cryogenic storage system as described above. The communications settings, thus established, can be stored in memory 204.

A component interface 214 is also provided to couple controller 130 to various components of cryogenic storage system 100. For instance, component interface 214 can connect controller 130 to sensor systems such as differential pressure system 112, thermistor system 114, supply level system 116, vacuum measurement system 118, oxygen level measurement system 120. The component interface 214 may also couple the controller 130 to various devices such as valves and switches that are activated or manipulated to control aspects of the cryogenic storage system 100. Accordingly, component interface 214 can include a plurality of electrical connections on a circuit board or internal bus of controller 130 that is further coupled to processor 202, memory 204, etc. Further, the component interface 214 can implement various wired or wireless interfaces such as, but not limited to, a USB interface, a serial interface, a WiFi interface, a short-range RF interface (Bluetooth), an infrared interface, a near-field communication (NFC) interface, etc.

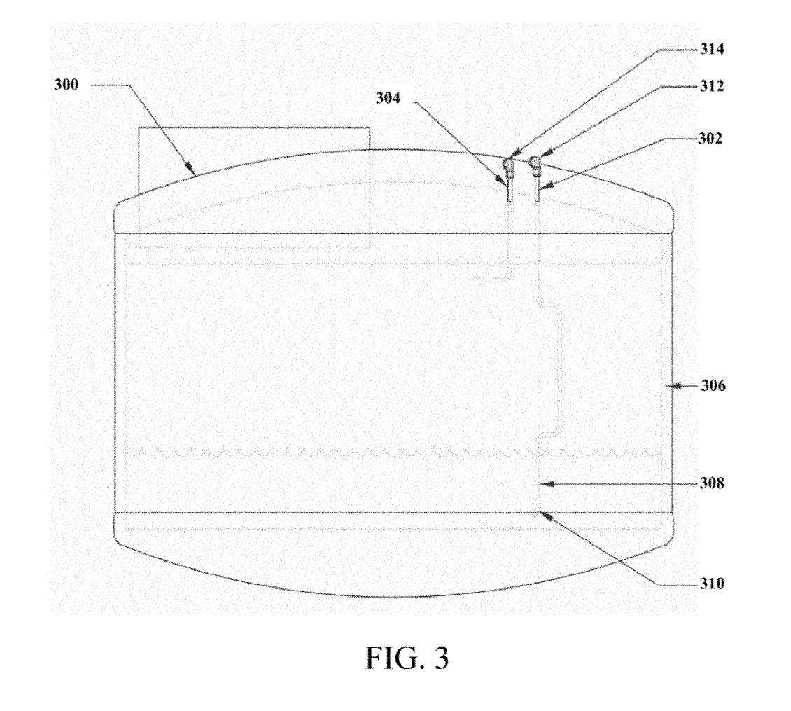

Turning now to FIG. 3, illustrated is an exemplary, non-limiting embodiment of a differential pressure system for a cryogenic storage system. In particular, FIG. 3 depicts portions of the differential pressure system coupled to or associated with a storage vessel 300, which can be similar to storage vessel 102 described above. The differential pressure system includes two tubes that penetrate an upper head of the vessel 300 and extend downward. A first tube 302, which is a high pressure tube, extends along a vertical height of the vessel 300 to a lower head of the vessel 300 through an annular space 306 of the vessel 300. The annular space exists between an outer wall and an inner wall of the vessel 300. The first tube 302 may run proximal to the outer wall of the vessel 300 to allow some heat to enter the tube to promote limited evaporation of LN₂. The evaporation produces nitrogen gas which creates a gas trap 308 while liquid nitrogen remains near a bottom portion 310 of the first tube 302. In the lower head of the vessel 300, the first tube 302 penetrates the wall of an inner chamber at point below the level of liquid nitrogen inside the vessel 300. Penetration at this point allows liquid nitrogen to enter the first tube 302. A second tube 304, which is a low pressure tube, extends a relatively shorter distance to penetrate the inner chamber at a location above the pool of liquid nitrogen in the vessel 300.

The liquid nitrogen inside the vessel 300 pushes against the gas trap 308 in the first tube 302 to provide a first pressure that can be measured (e.g. a high pressure). As more LN₂ is introduced into the vessel 300, there is a harder push against the gas trap 308. The second tube 304 provides a second measurable pressure corresponding to a pressure above the pool of liquid nitrogen. In a static state or when a lid of the vessel 300 is open, the second pressure approaches atmospheric pressure. During a filling operation, liquid nitrogen travels from the storage container (e.g. supply container 104) to the vessel 300. As the liquid nitrogen travels, it cools the fill lines and plumbing assembly (not shown) of the vessel 300. This cooling process generates mixed phase nitrogen composed of both liquid and gas. As the mixed phase nitrogen enters the vessel 300 during the filling operation, more evaporation occurs as when the mixed phase nitrogen hits the pool of liquid nitrogen in the vessel 300. Since liquid nitrogen can expand by a ratio of 1:696, a pressure buildup can occur in the vessel 300. The pressure buildup in the vessel 300, however, is cancelled out because it is measured on both the high pressure tube 302 and the low pressure tube 304 of the vessel 300. That is, the pressure buildup during a filling operation does not affect the level measurement provided by the differential pressure system depicted in FIG. 3.

As shown in FIG. 3, the high pressure or first tube 302 includes a barbed fitting installed on the portion exposed outside the upper head of the vessel 300. The barbed fitting can be connected to a first tygon tube 312. The first tygon tube 312 extends to a barbed fitting of a controller associated with a high pressure port of a differential pressure transducer. Similarly, the second tube 304 includes a barbed fitting connected to a second tygon tube 314. The second tygon tube 314 extends to a barbed fitting of a controller associated with a low pressure port of the differential pressure transducer. The controller interprets the differential pressure and determines a liquid level within the vessel 300.

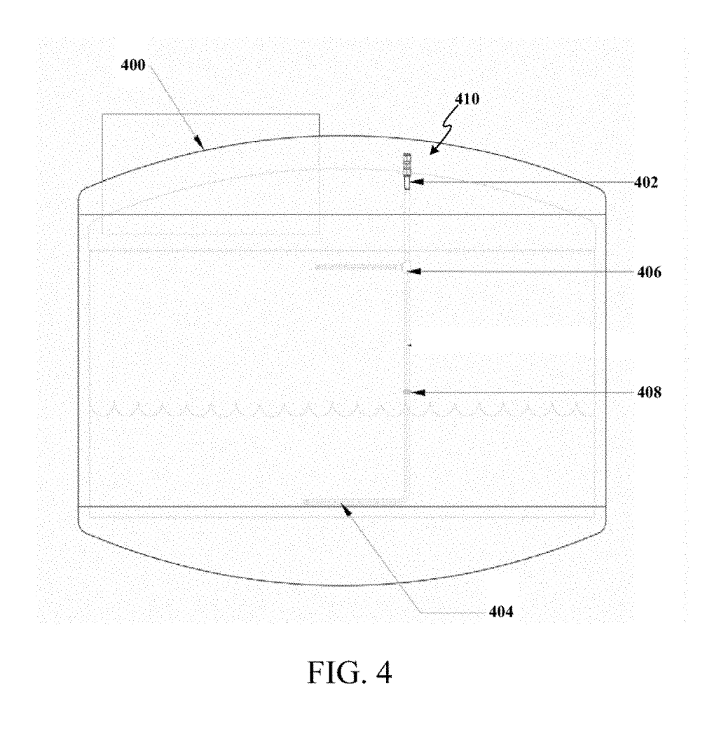

Turning to FIG. 4, illustrated is an exemplary, non-limiting embodiment of a thermistor-based level measurement system for a cryogenic storage system. In particular, FIG. 4 depicts portions of the thermistor-based level measurement system coupled to or associated with a storage vessel 400, which can be similar to storage vessel 102 described above. The thermistor-based level measurement system includes negative temperature coefficient (NTC) thermistors. NTC thermistors are thermal resistors which exhibit large resistance changes when the temperature gets colder. At ambient temperature, for example, the NTC thermistor can have a resistance of approximately 5-12Ω. As the temperature get colder and approaches cryogenic temperatures, the resistance can be in the range of approximately 23-38 KΩ.

According to an aspect, the NTC thermistors are installed on a printed circuit board (PCB) such that at least four thermistors are positioned within a normal operating range of standard level control. That is, these four thermistors may correspond to positions (e.g., fluid levels) associated with a Low Level Alarm parameter, a Start Fill parameter, Stop Fill parameter, and High Level Alarm parameter. Other thermistors can be spaced equidistant throughout a remainder of a vertical height of the PCB to verify level measurements at multiple points throughout the normal operating range of the vessel 400.

As shown in FIG. 4, a thermistor assembly 410 includes a tube 402 that penetrates the upper head of the vessel 400 and extends downward. The tube 402, which can be referred to as the thermistor assembly tube, extends, through an annular space between an outer wall and an inner wall and along a vertical height of the vessel 400, to a lower head of the vessel 400. In the lower head, the tube 402 penetrates the inner wall the vessel 400 into an inner chamber at a point 404 sufficient to allow liquid nitrogen to enter the tube 402. As shown in FIG. 4, tube 402 includes a T-junction 406 with an extension that penetrates the inner chamber above the pool of liquid nitrogen. As the liquid nitrogen level inside the vessel 400 rises, more liquid will enter the tube 402 at the penetration point 404. The liquid nitrogen within in the tube 402 will rise to a level 408 that corresponds to the level of liquid nitrogen inside the vessel 400. The extension off the T-junction 406 prevents gas from being trapped in the tube 402 and, thus, allows liquid to enter the tube 402 and rise while N₂ gas inside the tube 402 is pushed back into the inner chamber of the vessel 400.

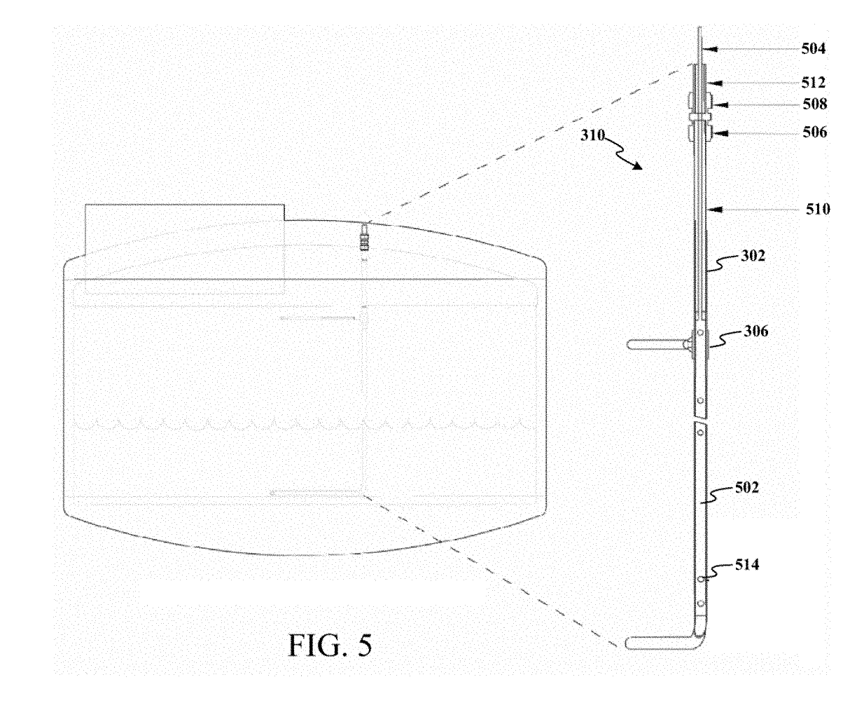

Turning to FIG. 5, the thermistor assembly 312 includes a circuit board 502 that is configured to accommodate installation of the thermistors 514. At an upper portion of the circuit board 502, a cable 504 connected to transmit signals from the thermistors 514 to a controller (such as control system 110 described above). The cable 504 carries a fitting with one side being a tube compression fitting 506 and another side being a NPT pipe fitting 508. The tube fitting 506 can be installed over a portion 510 of tube 302 extending from T-junction 306 to the outside of the vessel 300. A cord grip 512 is additionally installed on the cable 504. The circuit board 502 is placed in tube 302 so that the circuit board 502 abuts a bottom portion of the tube 302 as shown in FIG. 5. The cord grip 512 is installed into the NPT pipe fitting 508 and tightened to hold the cable 504 in place. The cord grip 512 and pipe fitting 508 provide an air seal between the tube 302 and an external environment to prevent ice formation.

According to an aspect, the cable 504 is coupled to a controller via, for example, a round 12 pin connector. The controller receives signals from the thermistors 514, interprets the respective resistances from the thermistors 514, and determines a level of liquid nitrogen in the vessel 300. It is to be appreciated that the thermistor assembly 412 may wirelessly communicated with the controller, such as controller 130.

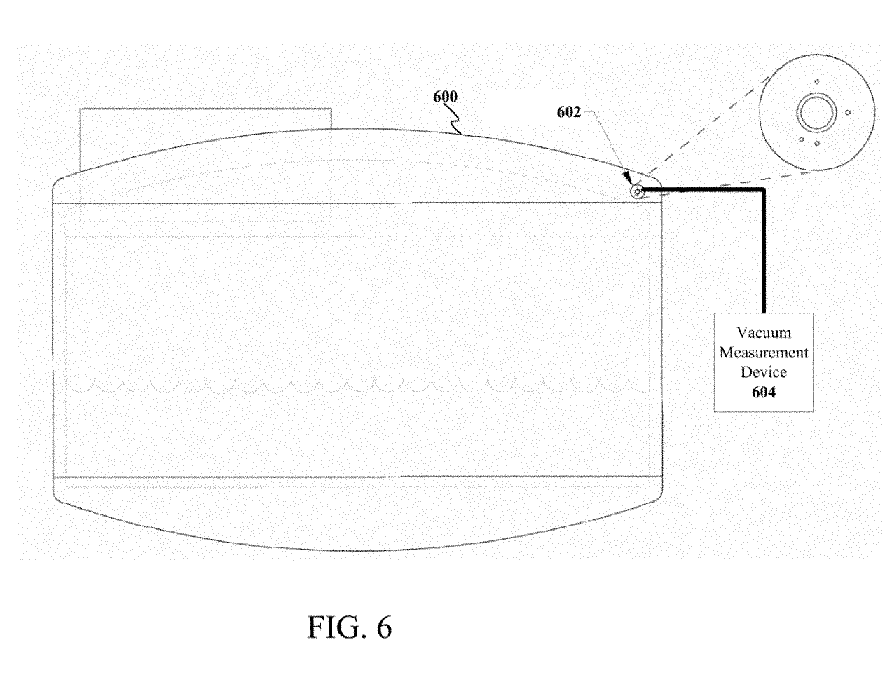

Turning to FIG. 6, illustrated is an exemplary, non-limiting embodiment of a vacuum integrity monitor according to an aspect. Vessel 600 includes a vacuum port 602, which is a physical attachment point where a vacuum pump may be connected to draw a vacuum between the inner wall and the outer wall of vessel 600. A vacuum measurement device 604 can be coupled to the vacuum port 602 and periodically send measurements on the vacuum to a controller, such as control system 110 of FIG. 1. The measurements can be sent in response to a request from the controller, for example. The controller can, according to an aspect, forward the data to a cloud-based platform for redundant storage and analysis.

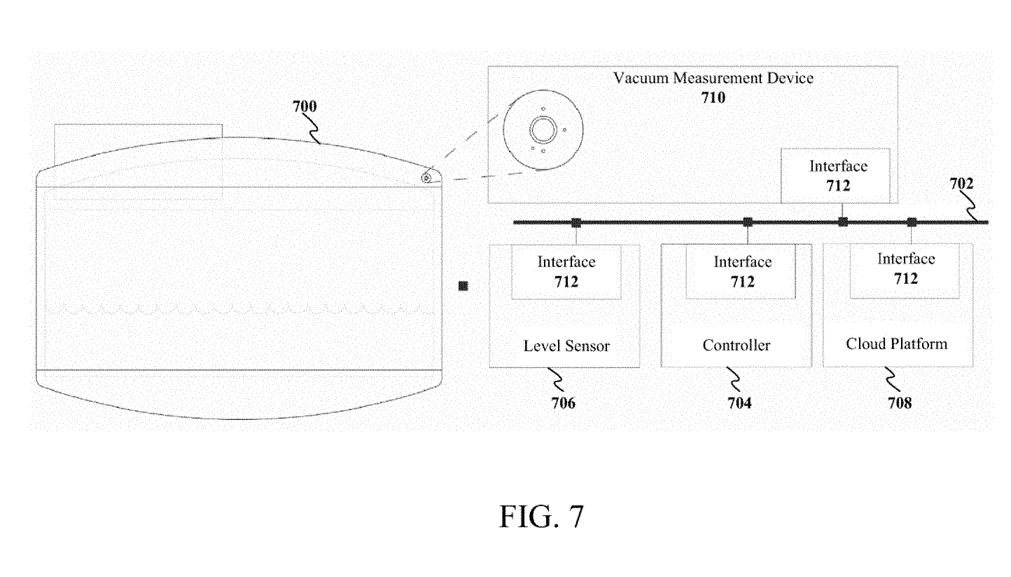

FIG. 7 illustrates an exemplary, non-limiting embodiment of system communications in accordance with an aspect. A communication bus 702 is associated with vessel 700 and communicatively couples various sensor and measurement systems to control systems. For example, the system can include a controller 704, a level sensor 706, a cloud platform 708, and a vacuum measurement device 710. It is to be appreciated that other systems such as supply level system 116 and oxygen level measurement system 120 can also be coupled to the communication bus 702. Each component coupled to the bus 702 can include an interface 712 to facilitate connection to and communication with other components on the bus 702.

By way of example, the communication bus 702 can be a controller area network (CAN) bus and the interfaces 712 can be configured to implement a CRYOWIRE SECURE protocol on the CAN bus network to provide robust and secure communication among components. In this manner, a peer-to-peer communication scheme can be employed so that multiple devices can all communicate in an orderly fashion while ensuring that a failure of one device on the network does not affect the communication capabilities of other devices. Accordingly, any device implementing the CRYOWIRE SECURE protocol on the communication bus 702 can not only send data to the controller 704, but also directly to the cloud platform 708 (via a TCP/IP interface, for instance).

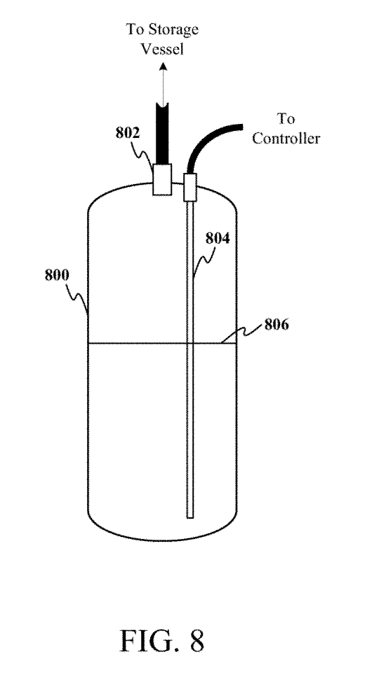

FIG. 8 depicts an exemplary, non-limiting embodiment of a storage container 800 with a level sensing system. As shown in FIG. 8, the storage container 800 can include a fill port 802 to facilitate a filling operation by which liquid nitrogen is communicated to a storage vessel. To provide information regarding a level 806 of liquid nitrogen available in storage container 800, a capacitance probe 804 is positioned within the storage container 806. The probe 804 provides a signal indicative of level 806 to a controller. A pressure sensor can also be coupled to the storage container 800 to provide pressure data. In one example, the data can be converted to CRYOWIRE SECURE format for communication on the CAN bus network described above.

A controller can utilize the data to determine whether to start a filling operation, stop a filling operation, or conserve supply. For instance, if the level 806 is low, the controller can delay the filling operation to stretch the available supply. As shown in FIGS. 1 and 7, the data can also be communicated to a cloud platform to trigger notification sent to operators and/or distributors to provide new supply when needed.

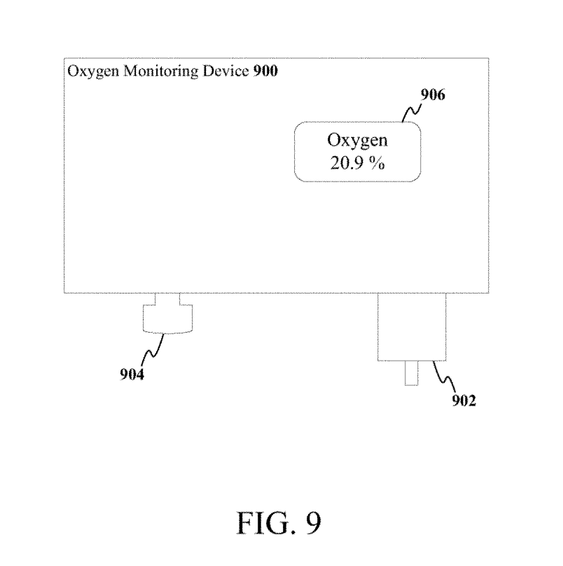

Turning now to FIG. 9, an exemplary oxygen monitor 900 is illustrated. The monitor includes an oxygen sensor 902 and a communication port 904 to enable the monitor 900 to communicate information specifying an oxygen level to a controller or other device. For example, the monitor 900 may be coupled to bus 702 and may implement the CYROWIRE SECURE protocol to transmit oxygen readings to a controller and/or the cloud platform. The oxygen monitor 900 may also include a display 906 that indicates a currently measured oxygen level.

A controller, such as controller 130 of control system 110 of FIG. 1, can provide various control functions when coupled to a storage vessel (e.g. a cryogenic freezer). These functions can include capabilities such as, but not limited to, controlling a liquid nitrogen level within the vessel, obtaining data from a differential pressure level measurement system to make decisions, obtaining data from a thermistor-based level measurement system to make decisions, obtaining data from a vacuum gauge to make decisions, obtaining data from a supply cylinder to make decisions, obtaining data from an oxygen monitor to make decisions, storing collected data, issuing local alarms when operating parameters vary from normal conditions, facilitating robust communications, and providing an interface to a cloud-based platform.

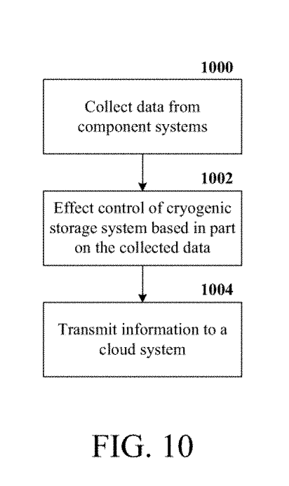

FIG. 10 illustrates a flow diagram of an exemplary, non-limiting method for controlling a cryogenic storage system. At 1000, data is collected from component systems such as level measurement systems (e.g. differential-pressured-based and/or thermistor-based), supply level measurement systems, oxygen monitoring systems, vacuum monitoring systems, temperature systems, or the like. At 1002, control of the cryogenic storage system is effected based in part on the collected data. For example, a filling operation may be initiated or stopped based on analysis of the collected data, alarms may be activated to alert operators of dangerous conditions, notifications may be communicated, and/or the configured parameters may be altered to account for non-standard operating conditions (e.g. low supply levels, loss of electrical power, excessive evaporation, etc.). At 1004, information may be transmitted to a cloud system. The information may include the data collected from component systems as well as other operational or historical data for the cryogenic storage system.

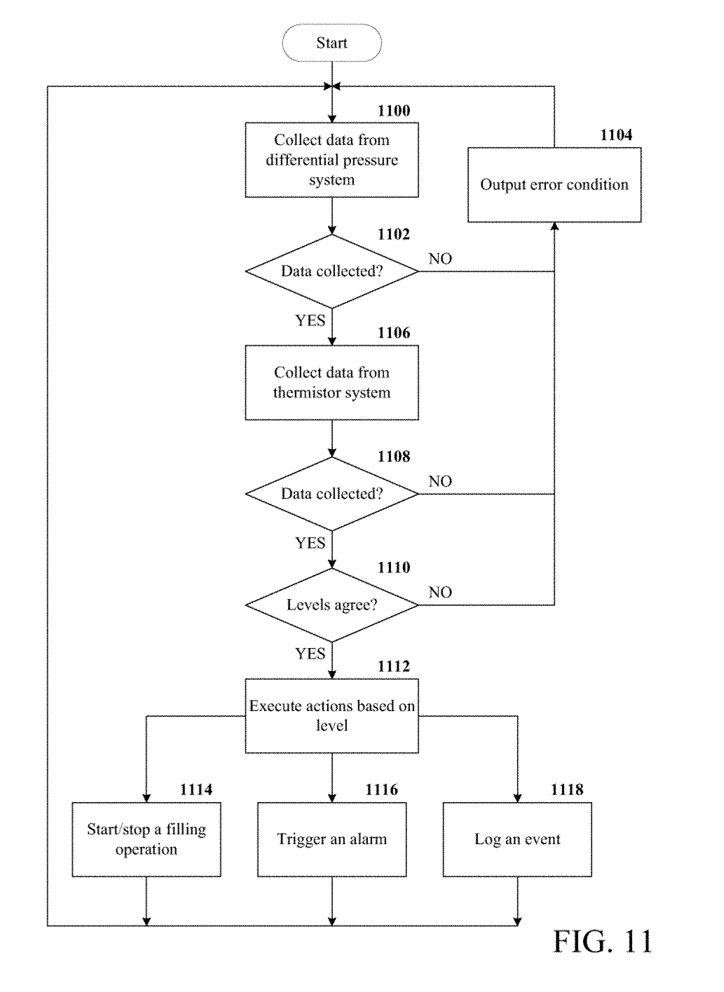

FIG. 11 illustrates a flow diagram of an exemplary, non-limiting method for utilizing level measurements in a cryogenic storage system. At 1100, data is collected from a differential pressure system. At 1102, a check is made as to whether data was actually collected. If not, the method transitions to 1104 where an error condition is output. If data is successfully collected, the method proceeds to step 1106 where data is collected from a thermistor-based system. Another check is made at 1108 to determine whether the data is successfully collected. If not, the error condition is output. Otherwise, the method proceeds to 1110 where the data collected from the differential pressure system is compared to the data collected from the thermistor-based system to determine whether the respectively measured levels agree. If there is no agreement, an error is output. Otherwise, the method continues to 1112 where actions are executed based on the measured level. For example, at 1114, a fill operation can be initiated or halted based on the level. At 1116, an alarm can be triggered if the level corresponds to an alarm condition. At 1118, an event can be logged.

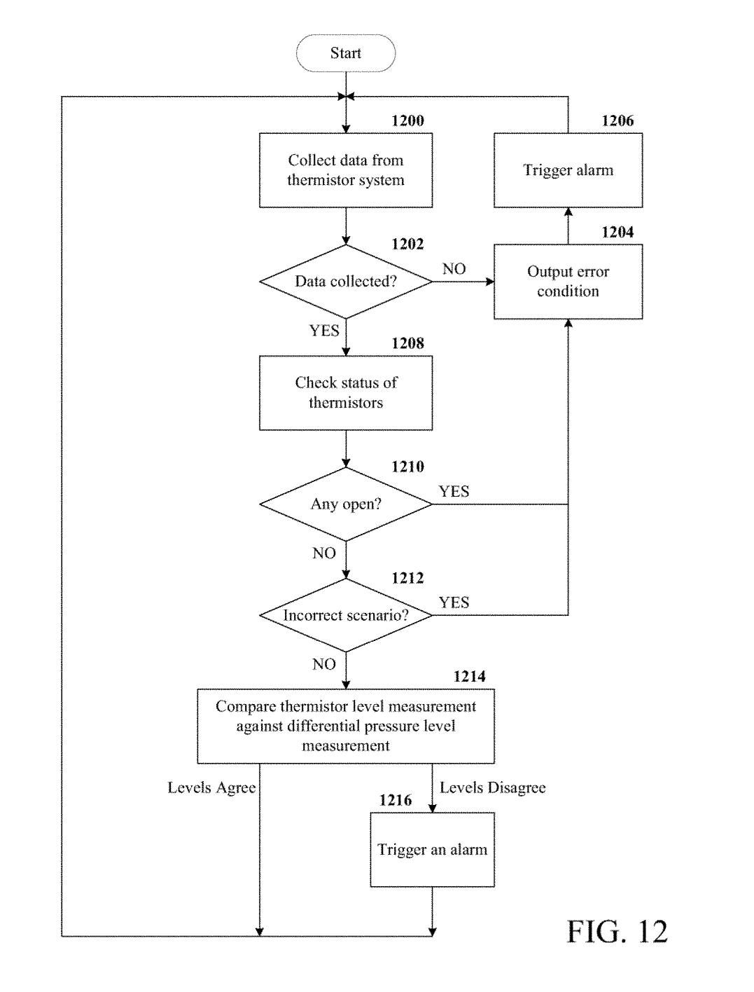

FIG. 12 illustrates a flow diagram of an exemplary, non-limiting method for utilizing a thermistor-based level sensing system in accordance with one or more aspects. At 1200, data is collected from a thermistor-based sensor system. At 1202, a check is made as to whether data was actually collected. If not, the method transitions to 1204 where an error condition is output and then an alarm is triggered at 1206. If data is successfully collected, the method proceeds to step 1208 where the status of the thermistors is checked. If any thermistors are open (1210), then an error is output (1204) and an alarm is triggered (1206). However, if all thermistors are operational, then the method proceeds to 1212 where the data collected from the thermistors is checked to determine whether an invalid scenario is reported. For instance, an invalid scenario can include a situation where the thermistors report inconsistent data such as reporting presence of liquid nitrogen at a point higher than another thermistor which does not detect liquid nitrogen. If an invalid scenario is reported, an error is output (1204) and an alarm is trigger (1206). Otherwise, at 1214, the data is compared to measurements provided by a differential pressure system. If the levels agree, the method is repeated to continue to verify measurements. If the levels disagree, an alarm is triggered at 1216.

In the methods of FIGS. 11 and 12, it is to be appreciated that level agreement is an optional implementation. For example, the cryogenic storage systems described herein may implement only a differential-pressure-based measurement system or only a thermistor-based measurement system.

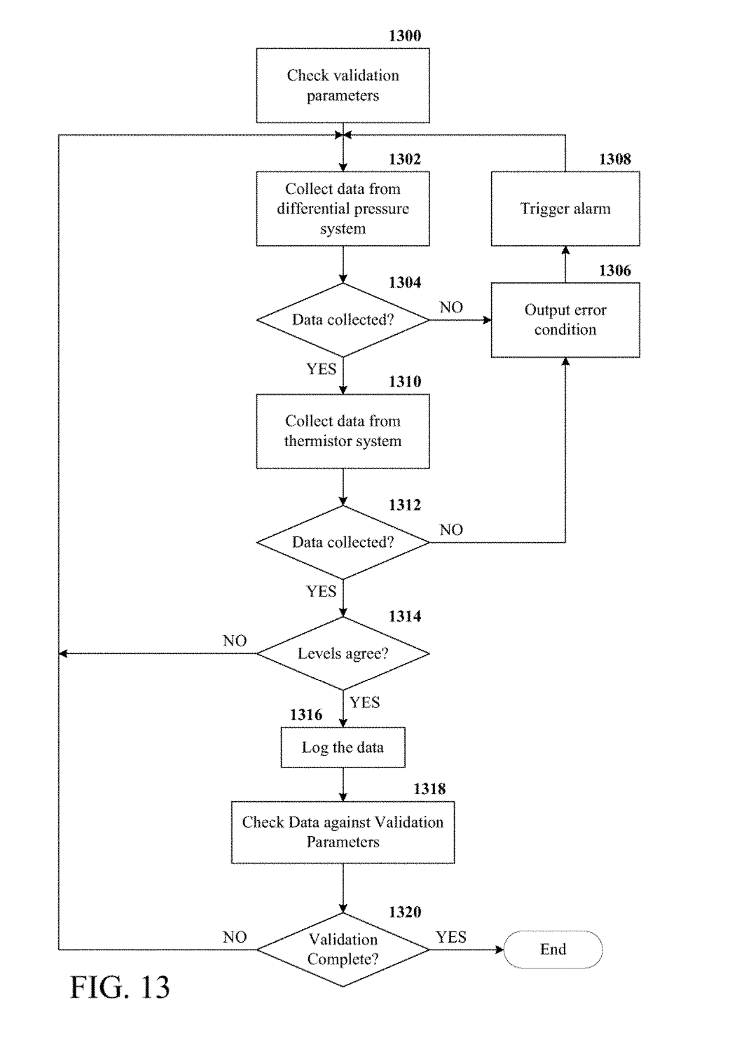

FIG. 13. illustrates a flow diagram of an exemplary, non-limiting method for automatically validating level measurements. The method commences at 1300 where validation parameters are checked. According to an aspect, validation parameters specify conditions by which level agreement is judged. For example, the validation parameters may established a threshold amount of disagreement that is acceptable for a determination of agreement. At 1302, data is collected from a differential pressure system. If the data is unsuccessfully collected, an output condition is output, and an alarm is triggered (1304, 1306, 1308). If data is successfully collected, the method proceeds to 1310 where data is collected from a thermistor-based system. Another check is made at 1312 to determine whether the data is successfully collected. If not, the error is output and the alarm is triggered. Otherwise, the method proceeds to 1314 where the levels are checked for agreement. The method restarts when the levels disagree. When levels agree, the data is logged at 1316 and the data is checked against the validation parameters at 1318. If validation is still needed, the method restarts. Otherwise, the method terminates.

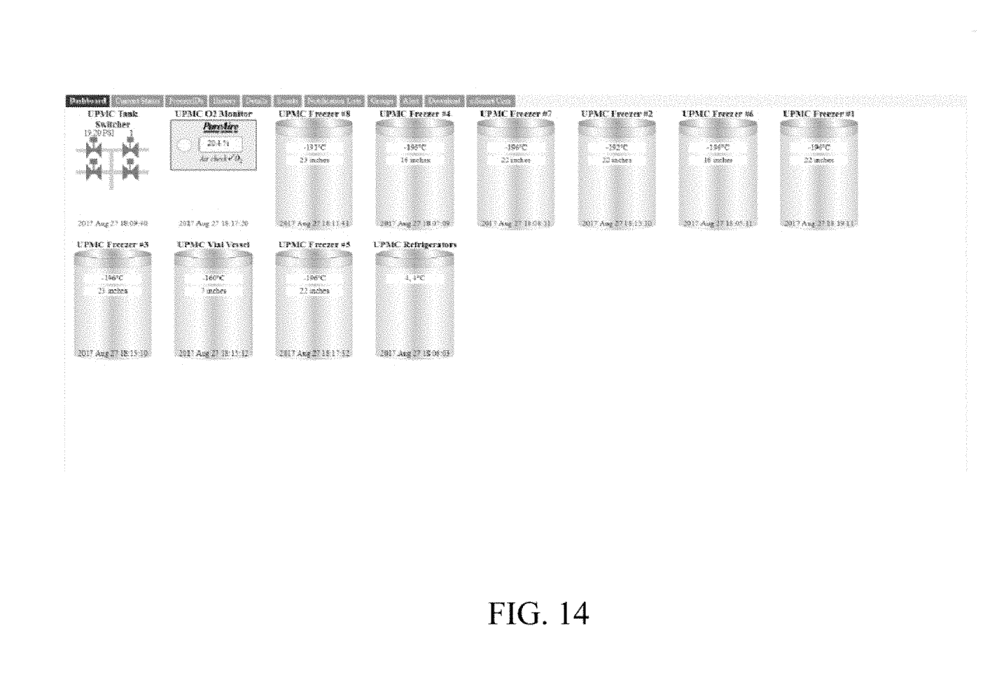

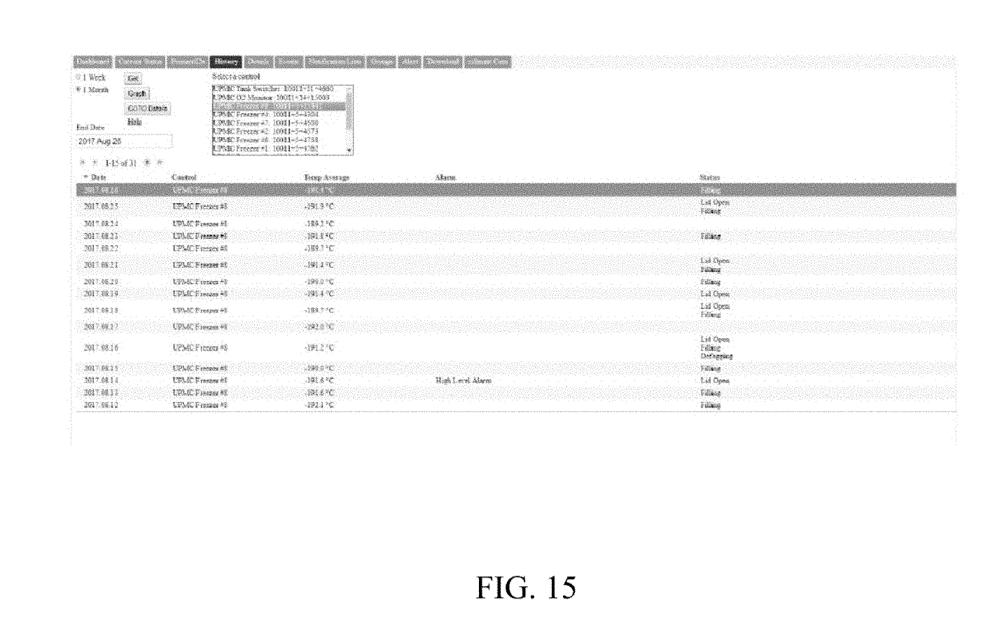

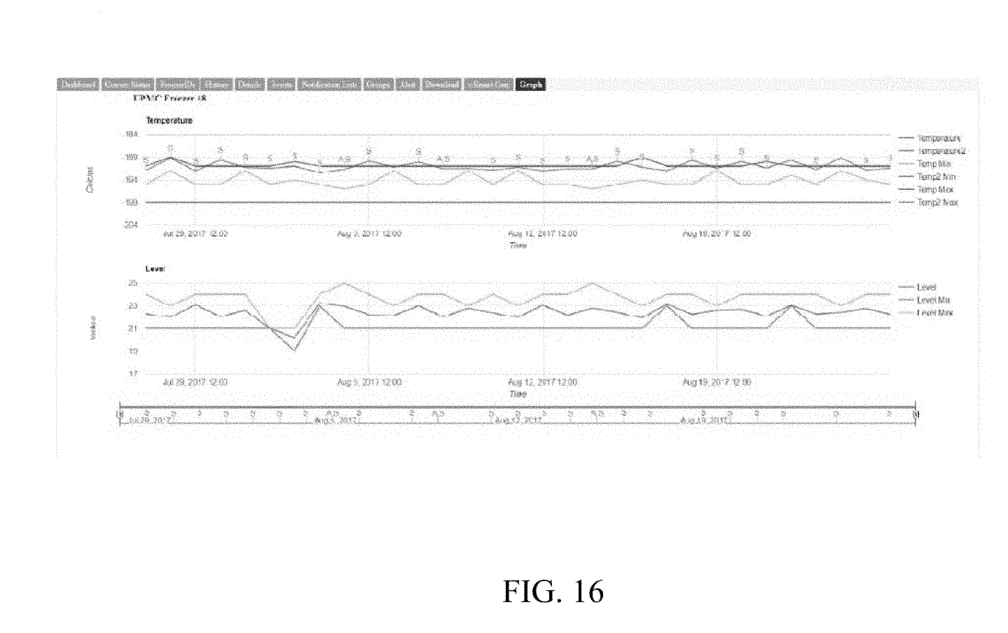

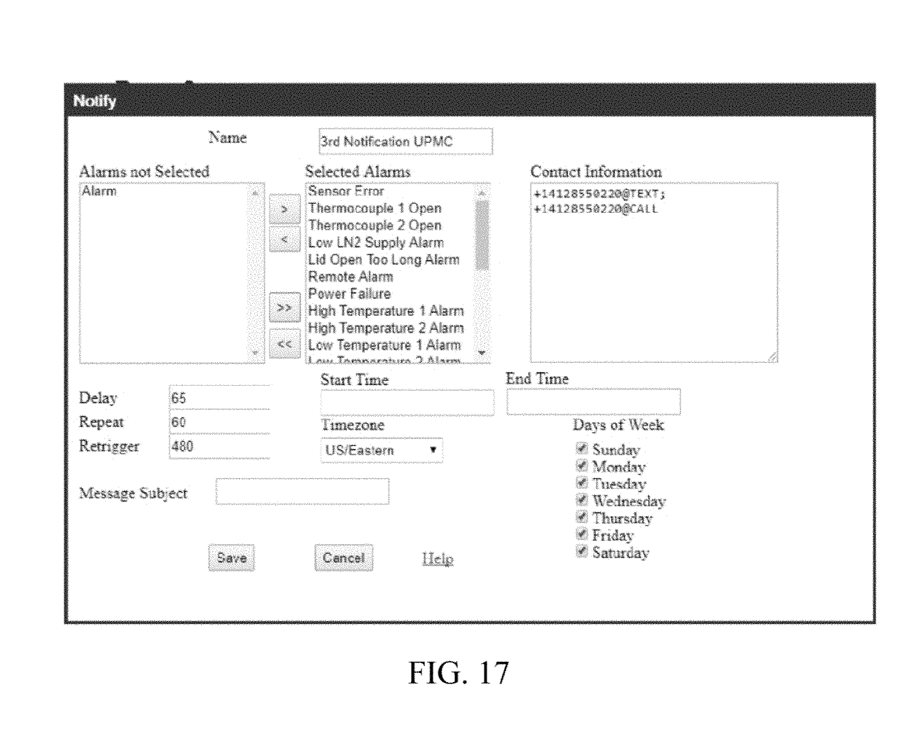

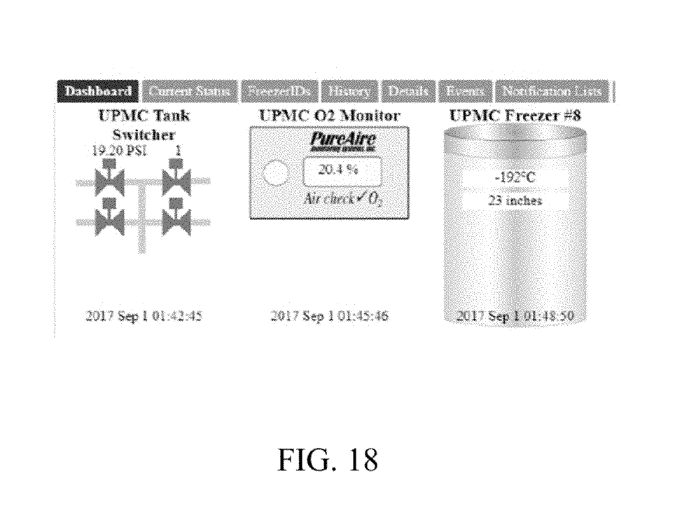

A cloud platform can provide data redundancy and improved data accessibility for a cryogenic storage system. For instance, the cloud platform can provide functionality such as, but not limited to, collecting operation data from liquid nitrogen freezers, collecting operational data from other laboratory equipment, providing real-time operational status of liquid nitrogen freezers and other laboratory equipment, providing historical data for audits, providing historical data to determine trends, providing charts to visual a complete set of data, and providing notifications on status or alarm conditions to different groups. FIGS. 14-16 depict exemplary screenshots of displays provided by an exemplary, non-limiting cloud platform. In particular, FIG. 14 depicts a dashboard display. FIG. 15 depicts a history display. FIG. 16 depicts a graph display to visual data. FIG. 17 shows a notifications display to enable customization of notifications. FIG. 18 shows a display depicting integration of the cloud-based platform with an oxygen monitor.

One of ordinary skill in the art can appreciate that the various embodiments of a cryogenic storage system and/or cloud system described herein can be implemented in connection with any computing device, client device, or server device, which can be deployed as part of a computer network or in a distributed computing environment such as the cloud. The various embodiments described herein can be implemented in substantially any computer system or computing environment having any number of memory or storage units, any number of processing units, and any number of applications and processes occurring across any number of storage units and processing units. This includes, but is not limited to, cloud environments with physical computing devices (e.g., servers) aggregating computing resources (i.e., memory, persistent storage, processor cycles, network bandwidth, etc.) which are distributed among a plurality of computable objects. The physical computing devices can intercommunicate via a variety of physical communication links such as wired communication media (e.g., fiber optics, twisted pair wires, coaxial cables, etc.) and/or wireless communication media (e.g., microwave, satellite, cellular, radio or spread spectrum, free-space optical, etc.). The physical computing devices can be aggregated and exposed according to various levels of abstraction for use by application or service providers, to provide computing services or functionality to client computing devices. The client computing devices can access the computing services or functionality via application program interfaces (APIs), web browsers, or other standalone or networked applications. Accordingly, aspects of the cryogenic storage system can be implemented based on such a cloud environment. For example, cloud system 122 can reside in the cloud environment such that the computer-executable instruction implementing the functionality thereof are executed with the aggregated computing resources provided by the plurality of physical computing devices. The cloud environment provides one or more methods of access to the cloud system 122, which are utilized by control system 110 or other client devices. These methods of access include IP addresses, domain names, URIs, etc. Since the aggregated computing resources can be provided by physical computing device remotely located from one another, the cloud environment can include additional devices such as a routers, load balancers, switches, etc., that appropriately coordinate network data.

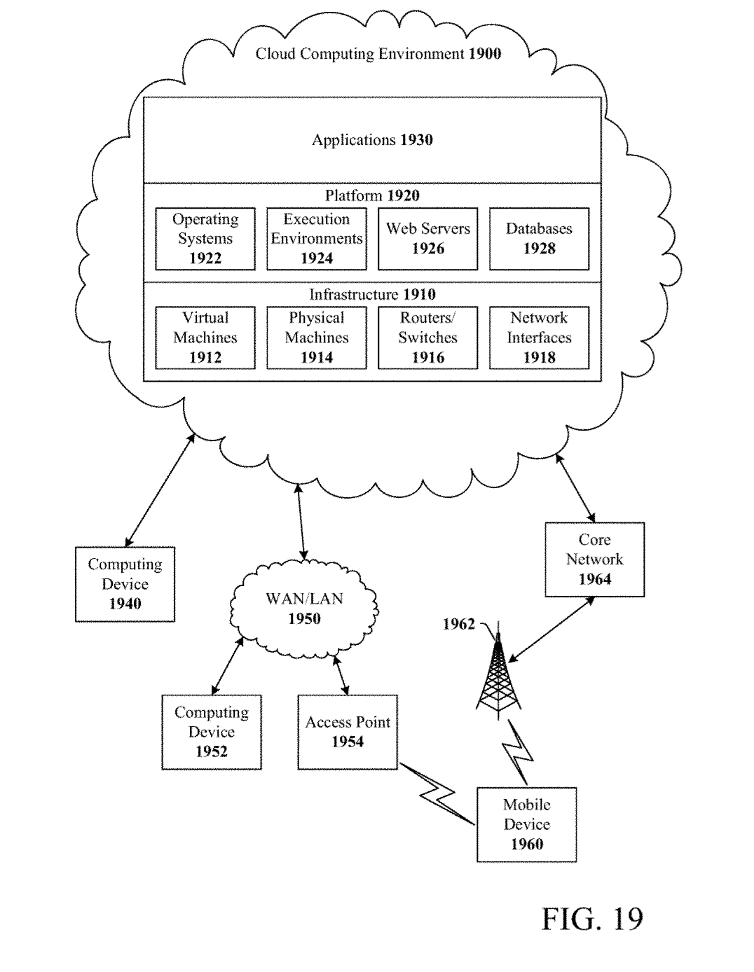

FIG. 19 provides a schematic diagram of an exemplary networked or distributed computing environment, such as a cloud computing environment 1900. The cloud computing environment 1900 represents a collection of computing resources available, typically via the Internet, to one or more client devices. The cloud computing environment 1900 comprises various levels of abstraction: infrastructure 1910, a platform 1920, and applications 1930. Each level, from infrastructure 1910 to applications 1930 is generally implemented on top of lower levels, with infrastructure 1910 representing the lowest level.

Infrastructure 1910 generally encompasses the physical resources and components on which cloud services are deployed. For instance, infrastructure 1910 can include virtual machines 1912, physical machines 1914, routers/switches 1916, and network interfaces 1918. The network interfaces 1918 provide access to the cloud computing environment 1900, via the Internet or other network, from client devices such as computing devices 1940, 1952, 1960, etc. That is, network interfaces 1918 provide an outermost boundary of cloud computing environment 1900 and couple the cloud computing environment 1900 to other networks, the Internet, and client computing devices. Routers/switches 1916 couple the network interfaces 1918 to physical machines 1914, which are computing devices comprising computer processors, memory, mass storage devices, etc. Hardware of physical machines 1914 can be virtualized to provide virtual machines 1912. In an aspect, virtual machines 1912 can be executed on one or more physical machines 1914. That is, one physical machine 1914 can include a plurality of virtual machines 1912.

Implemented on infrastructure 1910, platform 1920 includes software that forming a foundation for applications 1930. The software forming platform 1920 includes operating systems 1922, programming or execution environments 1924, web servers 1926, and databases 1928. The software of platform 1920 can be installed on virtual machines 1912 and/or physical machines 1914.

Applications 1930 include user-facing software applications, implemented on platform 1920, that provide services to various client devices. In this regard, the cloud system 122 of the cryogenic storage system 100 described herein is an example application 1930. As illustrated in FIG. 19, client devices can include computing devices 1940, 1952 and mobile device 1960. Computing devices 1940, 1952 can be directly coupled to the Internet, and therefore the cloud computing environment 1900, or indirectly coupled to the Internet via a WAN/LAN 1950. The WAN/LAN 1950 can include an access point 1954 that enables wireless communications (e.g., WiFi) with mobile device 1960. In this regard, via access point 1954 and WAN/LAN 1950, mobile device 1960 can communicate wirelessly with the cloud computing environment 1900. Mobile device 1960 can also wirelessly communicate according to cellular technology such as, but not limited to, GSM, LTE, WiMAX, HSPA, etc. Accordingly, mobile device 1960 can wirelessly communicate with a base station 1962, which is coupled to a core network 1964 of a wireless communication provider. The core network 1964 includes a gateway to the Internet and, via the Internet, provides a communication path to the cloud computing environment 1900.

As mentioned above, while exemplary embodiments have been described in connection with various computing devices and network architectures, the underlying concepts may be applied to any network system and any computing device or system in which it is desirable to implement an image segmentation system.

Also, there are multiple ways to implement the same or similar functionality, e.g., an appropriate API, tool kit, driver code, operating system, control, standalone or downloadable software objects, etc. which enables applications and services to take advantage of the techniques provided herein. Thus, embodiments herein are contemplated from the standpoint of an API (or other software object), as well as from a software or hardware object that implements one or more embodiments as described herein. Thus, various embodiments described herein can have aspects that are wholly in hardware, partly in hardware and partly in software, as well as in software.

It is to be appreciated that various features or aspects of the embodiments described herein can be utilized in any combination with any of the other embodiments.

As utilized herein, the term “or” is intended to mean an inclusive “or” rather than an exclusive “or.” That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form. Further, as used herein, the term “exemplary” is intended to mean “serving as an illustration or example of something.”

Illustrative embodiments have been described, hereinabove. It will be apparent to those skilled in the art that the above devices and methods may incorporate changes and modifications without departing from the general scope of the claimed subject matter. It is intended to include all such modifications and alterations within the scope of the claimed subject matter. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A cryogenic storage system, comprising:
a storage vessel having a storage chamber and configured to contain a cryogenic liquid to provide a cryogenic temperature within the storage chamber suitable for cryogenic storage of items;
a dual-layer level measurement system configured to provide redundant measurement of a level of the cryogenic liquid within the storage vessel; and
a controller configured to obtain level measurements from the dual-layer level measurement system and to control filling operations for the storage vessel based at least in part on the level measurements.

2. The system of claim 1, wherein the dual-layer level measurement system includes a differential-pressure-based level measurement system.

3. The system of claim 1, wherein the dual-layer level measurement system includes a thermistor-based level measurement system.

4. The system of claim 2, wherein the differential-pressure-based level measurement system comprises:
a first tube that penetrates into the storage chamber of the storage vessel at a point below the level of cryogenic liquid; and
a second tube that penetrates into the storage chamber at a point above the level of cryogenic liquid,
wherein the first tube provides a high pressure measurement and the second tube provides a low pressure measurement.

5. The system of claim 4, wherein the controller is further configured to analyze the high pressure measurement and the low pressure measurement to determine the level of cryogenic liquid within the storage vessel.

6. The system of claim 3, wherein the thermistor-based level measurement system comprises:
a tube having a first penetration into the storage chamber of the storage vessel at a point below the level of cryogenic liquid and a second penetration at a point above the level of cryogenic liquid; and
a circuit board mounted within the tube and carrying a set of thermistors.

7. The system of claim 6, wherein the thermistors of the set of thermistors are positioned on the circuit board at discrete points corresponding to particular levels of liquid.

8. The system of claim 7, wherein the particular levels of liquid include a lower alarm level, a start fill level, a stop fill level, and a higher alarm level.

9. The system of claim 6, wherein the thermistor-based level measurement system further comprises a cable for communicating signals from the thermistors to the controller,
wherein the controller is further configured to interpret respective resistances of the set of thermistors to determine the level of cryogenic liquid within the storage vessel.

10. The system of claim 1, further comprising a storage container storing a supply of cryogenic liquid for the storage vessel, wherein the storage container includes a level sensor configured to communicate a level of fluid stored in the storage container to the controller.

11. The system of claim 1, further comprising a vacuum measurement device coupled to a vacuum port of the storage vessel and configured to measure a vacuum integrity of the storage vessel.

12. The system of claim 1, further comprising an oxygen monitor configured to measure an oxygen level in a vicinity of the storage vessel and communicate the oxygen level to the controller.

13. The system of claim 1, further comprising a cloud platform configured to collect operational data of the cryogenic storage system, analyze the operational data for trends, and communicate notifications to users in response to identified conditions.

14. A method for a cryogenic storage system, comprising:
collecting data from a differential-pressure-based level measurement system;
determining a first level of cryogenic fluid within a storage vessel based on the data from the differential-pressure-based level measurement system;
collecting data from a thermistor-based level measurement system;
determining a second level of cryogenic fluid within the storage vessel based on the data from the thermistor-based level measurement system; and
controlling filling operations for the storage vessel based at least in part on the first and second levels of cryogenic fluid.

15. The method of claim 14, further comprising triggering alarms based on the first and second levels of cryogenic fluid.

16. The method of claim 14, further comprising:
comparing the first level and the second level; and
determining that the first level and second level agree in accordance with validation parameters.

17. The method of claim 16, wherein the validation parameters specify a threshold level of disagreement between the first and second levels that is acceptable to determine the levels agree.

18. The method of claim 14, wherein the thermistor-based level measurement system comprises a set of thermistors and the data collected from the thermistor-based level measurement system includes a resistance value for each thermistor of the set of thermistors.

19. The method of claim 19, further comprising determining whether the resistance values for each thermistor of the set of thermistors specify an invalid scenario.

20. A system, comprising:
a cryogenic storage vessel having a storage chamber configured to contain a cryogenic fluid to provide a cryogenic temperature within the storage chamber;
a differential-pressure-based level measurement system configured to determine a first level measurement of the cryogenic fluid within the storage chamber;
a thermistor-based level measurement system configured to determine a second level measurement of the cryogenic fluid within the storage chamber;
a supply container storing a supply of cryogenic liquid for the cryogenic storage vessel, wherein the supply container includes a level sensor configured to measure a level of fluid stored in the supply container;
a vacuum measurement device coupled to a vacuum port of the cryogenic storage vessel and configured to measure a vacuum integrity of the cryogenic storage vessel;
an oxygen monitor configured to measure an oxygen level in a vicinity of the cryogenic storage vessel;
a controller configured to obtain data from the differential-pressure-based level measurement system, the thermistor-based level measurement system, the level sensor of the supply container, the vacuum measurement device, and the oxygen monitor, herein the controller executes control actions based on the obtained data; and
a cloud system configured to collect operational data of the system, analyze the operational data for trends, and communicate notifications to users in response to identified conditions.
